(19) United States
(12) Patent Application Publication
(10) Pub. No.: US 2010/0320234 A1
(43) Pub. Date: Dec. 23, 2010

(54) DEVICE FOR APPLYING PASTE PRODUCTS

(76) Inventor: Olexandr Punchenko, El Masnou (ES)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/739,486

(22) PCT Filed: Oct. 24, 2008
(86) PCT No.: PCT/ES2008/000660

§ 371 Date: Jul. 22, 2010

(30) Foreign Application Priority Data
Oct. 26, 2007 (ES) U200702183
Dec. 11, 2007 (ES) U200702549

(51) Int. Cl. B65D 88/66; G01F 11/00

(52) U.S. Cl. 222/196; 222/386

(57) ABSTRACT

The subject of this invention is a device for applying paste products which includes a cartridge of paste material secured to a case, with means for impelling the paste material and means of activation. The impeller unit (26) is formed by a cylindrical head (2), with a frontal cover (4) with a central aperture (35) and a perimetral border (36) where the cartridge piston is attached. The head is associated with a sleeve (23) by means of screws (6) and (30), the sleeve (23) being joined to a number of discs (3, 24) which, by means of a clutch (34), jointly rotate a shaft (7, 8) of an electric motor (17) connected to driving means and to an epicycloidal gear reducer (15). The impeller unit is secured to the case by means of a number of mobile supports (5) equipped with incisive elements (9). It is provided with cells/batteries (19) in their housing. The impeller means may be vibratory, preferably an electromagnetic vibrator.

The subject of this invention is a device for applying paste products, especially designed for the automatic application of a paste material disposed in a conventional cartridge through a nozzle opening, said applicator device comprising, in addition to the cartridge of paste material, housing means for said cartridge, propelling means for the cartridge, and means that permit its functioning automatically and optionally autonomously.

### PRIOR ART

Applicator devices for paste materials such as silicone materials, sealing materials, adhesives, anti-oxidant materials, greases and similar materials exist on the market and are therefore considered as the prior art; these devices are composed of cylinders provided with a piston and are operated manually by the user in such a way that the materials are discharged through one of its ends and through the corresponding nozzle opening and are applied at the desired points.

Guns provided with a plunger or a piston that is operated by means of the corresponding lever and whose function is to apply paste products at desired points are also found on the market. In some cases, these guns act on the piston by means of compressed air applied by a small compressor, which must be connected to the electrical grid in order to generate compressed air.

However, these applicator device configurations, on the one hand, imply rather long operating times and also require great force on the part of the users of such devices due to the force necessary to propel the material to the nozzle opening of said applicator device. Finally, the devices that require outside assistance, such as compressed air, are inefficient under certain circumstances when the points to be glued/sealed/silicone-treated do not have access to the electrical grid, or even if they do have access, reduced space makes such operations difficult if not impossible.

### SUBJECT OF THE INVENTION

The essence of the applicator device that is the subject of the present invention is to permit the application of paste materials that are currently being executed by manual means in guns or applicator cylinders of these materials to be performed in a totally automated manner, i.e., only by operating a push button, and to be operated autonomously, i.e., outside assistance such as compressed air is not needed. The advantages that automated operation for the application of paste material bestows are not only based on improving [reducing]* operating time, but also on improving the ergonomic work conditions for the user. Terms in brackets are added by the translator.

The applicator device for paste products of the present invention essentially comprises:
A cartridge of paste material of the conventional type;
Means for housing and fastening the cartridge and the other parts of the applicator device;
Means for propelling the paste material;
Means that permit the automatic and autonomous functioning of the propulsion means; and
Means for operating/stopping the propulsion unit.

Conventional cartridges for paste material are composed of a container in which the paste material is found in the front part and a piston is accommodated in the back part in order to press said paste material to the front where there is a nozzle opening to discharge the material to the outside.

The propulsion means for the paste material contained inside the cartridge comprises a head of expanded configuration, preferably cylindrical, furnished with a cover in its front part and contacting the lateral front section of the internally threaded head, which has the task of moving toward the front and pushing the piston of the cartridge so that the paste product is discharged through the nozzle opening. In the inside front part of said head, a sleeve of cylindrical configuration of lesser width than the head is mounted, this sleeve being threaded on the outside, keeping the two elements (head and sleeve) joined via a connection by their respective coincident screw threads.

Preferably, the front cover of the head will be provided with a central aperture smaller than the total diameter, and whose perimeter border will form a coupling with the cartridge piston in order to guarantee a complete sealing between the head and the cartridge.

Preferably, the screw threads of both elements will be straight, although they may have a shape that is more appropriate.

The means that permit the automatic and autonomous functioning of the propulsion means comprise an electric motor with an output shaft connected to a disk, and jointly connecting said disk to said sleeve.

Preferably, the electric motor is connected to an epicycloidal gear reducer which adapts the speed of the output shaft of the electric motor.

According to a first possible configuration, the gear reducer will have two output shafts, each of which is connected to a specific stage of the gear reducer so that these two shafts rotate at different speeds.

According to a second possible configuration, the gear reducer will have a single output shaft.

According to the first possible configuration, said sleeve works by rotating around its axis of rotation at two different speeds and in the two directions of rotation, in such a way that these rotational movements are transmitted to the head so that this head executes a slow longitudinal advance (during which it pushes the paste product) and a rapid return movement relative to the sleeve.

In order to achieve a change of rotational speed of the sleeve, a clutch is provided, which is disposed inside acting together with two rotating disks, each of which is joined to a different rotating shaft of the gear reducer. The two shafts (slow shaft and fast shaft) rotate at different speeds (slow and fast, respectively) when the applicator device is found in the operating mode. The clutch is then responsible for connecting the sleeve to the “fast” disk or to the “slow” disk, depending on whether the applicator device is in the advance mode or in the return mode. According to a particularly successful configuration of the propulsion means, the two shafts are mounted coaxially, i.e., one shaft is situated in line with the rotating shaft of the sleeve and the other shaft is disposed around the first shaft.

According to another alternative of the invention, the disk corresponding to the central shaft is immobilized at said central shaft by means of a bolt disposed in the front part of the disk. This bolt, in addition to fastening both elements, has the task of exercising pressure against the cartridge piston and bringing about the release of the front perimeter border of the head with the piston so as to be able to take apart the device.

According to the second configuration, the sleeve will have a single possible rotational speed, and therefore the head will execute an advance movement and a return movement at equal speed. In this case, obviously, only a single disk is mounted, which is joined with the rotating shaft, and there is no clutch.

On the other hand, the propulsion unit will provide several end-of-course sensors for the advance/return of the head through the inside of the sleeve, said sensors being activated via contact with the head when it reaches a specific position relative to the fixed part of the propulsion unit.

The electric motor receives the electrical power necessary to rotate the output shaft preferably from a battery or cells so that the applicator device is autonomous, although it is possible alternatively to connect it via a cable to the electrical grid. Said power source has been designed so that it can be fastened externally to the electric motor by its back part in a demountable manner, or even as an extension of the motor, following the cylindrical form of said device in an ergonomic manner, without altering the essence of the invention.

The housing and fastening means for the cartridge and the propulsion unit (including the head, the propulsion means, and the automatic functioning means) comprise an expanded case of ergonomic shape for the user, provided with a housing in the front part for accommodating the cartridge and a housing in the back part for accommodating the propulsion unit. Preferably, the case will have an aperture in its front base to permit the cartridge to be taken out through the front part.

Preferably, the propulsion unit will be mounted behind the cartridge so that a section of the lateral walls of the cartridge will be positioned over the outer surface of the head. Lastly, the case will be mounted above the outer surface of this section of the lateral walls of the cartridge. Then the front part of the case will contact by its inner surface the outer surface of this section of the lateral walls of the cartridge and the back part of the case will contact by its inner surface the fixed part of the propulsion unit.

The fastening means for the end section of the cartridge to the case are formed by several piercing elements in the case that are directed toward the cartridge, which are used to attach to the outer surface of the cartridge and thus to immobilize both elements.

The fastening means for the fixed part of the propulsion unit (electric motor+gear reducer) to the case are formed by several mobile supports that are mounted around the frame of the electric motor and that have several piercing elements on their front face, such as barbs in the form of metal filaments that project radially outward. When the electric motor is first operated, this assembly of piercing elements permits said mobile supports (with the assembly of piercing elements) to experience a radial displacement outward, which causes the ends of said piercing elements to put pressure on the inner walls of the case. In this way, it is achieved that the fixed part of the propulsion unit is kept immobilized at the inner walls of the case.

For the purpose of maximizing the fastening of the piercing elements to the inner walls of the case, these elements have the necessary angle relative to the longitudinal direction of the case, said angle being comprised preferably between 45° and 80°, and especially 45°.

The case provides means for operating the propulsion unit by the user, such as a start/stop button or an equivalent element.

In order to obtain a system that functions in a totally automatic manner, a control system is provided that is adapted so that once the electric motor is operated by turning on a switch the disk joined to the low-speed shaft is automatically engaged with the sleeve; and once the direction of rotation of the electric motor is changed by means of turning off the switch, the disk joined to the high-speed shaft is automatically engaged with the sleeve.

On the other hand, the control system will operate the rotation of the electric motor as soon as the start switch is turned on, and by turning the motor off, the rotation of the electric motor will be switched [reversed].

The functioning of the applicator device for paste products having two speeds according to the invention is the following:
First, the case is opened and a new cartridge of paste material is inserted.
The applicator device is operated by turning on a main switch, whereby the electric motor is started up and a rotation is induced with the gear reducer, which, on the one hand, causes the mobile supports together with the piercing elements to be displaced radially outward, pressing the fixed part of the propulsion unit against the inside surface of the case, and, on the other hand, causes the two shafts to rotate at different speeds.
The disk joined to the low-speed shaft is automatically engaged with the sleeve, whereby said sleeve will rotate jointly with the “slow” shaft at speed v1 (“slow”).
As a result of the fact that the sleeve is joined to the head by means of a screw thread connection, said head advances forward until its front cover runs up against the piston of the cartridge and subsequently after being pressed forward, the paste material begins to run out through the nozzle opening of the cartridge.
Once the applicator device is interrupted by means of turning off the main switch, the functioning of the electric motor is interrupted, and the two shafts automatically begin to rotate in opposite directions, whereby the mobile supports, together with the piercing elements are displaced radially inward.
The disk joined with the high-speed shaft automatically engages with the sleeve, whereby said sleeve will rotate jointly with the “fast” shaft at speed v2 (“fast”). The head remains immobile, fastened behind the piston of the cartridge, in a manner whereby the remainder of the propulsion unit (fixed part) is displaced backward the [same] distance that the head has advanced in the previous phase, the propulsion unit (fixed part) remaining stopped thanks to an run-end switch.

Although the provision of a main switch that operates the electric motor by turning it on and that interrupts said electric motor by turning it off has been conceived, other possible configurations may be used without altering the essence of the invention, for example, by means of providing two buttons (start button and stop button).

The multiple advantages of the applicator device of the invention, when compared with the devices conventionally used, are mainly that the force to extract the paste material is not manual, but rather automatic, which facilitates the work to a great extent, in addition to significantly increasing the homogeneity of the discharged material; and that the dimensions of the applicator device are notably smaller.

An alternative development of the applicator device is also presented in this patent, this development assuring that a regular and constant force is applied over the paste compound, without employing a compressor for its functioning, while the size of the applicator is such that it can be used with great precision in corners and surfaces with difficult access.

The particular feature of this development is based on providing means for propulsion and activation of a vibratory nature, preferentially formed by an electromagnetic or similar type of vibrator, these means administering the necessary pressure on transmission means joined to the vibratory means and comprising a base so as to provide a stop, thus exercising pressure against the posterior face of a piston for pushing the paste material, causing it to be discharged through a nozzle opening situated in the mouthpiece of the cartridge.

The means for supplying AC electrical current for the vibrator may be by directly connecting it to the electrical grid, or by means of providing several batteries in combination with a current inverter.

The vibratory means provided are located inside a container element, of expanded configuration and ergonomic form for the user. The container element provides a housing in the front part for accommodating a conventional cartridge and a housing in the back part for accommodating the propulsion unit. Two types of cartridges are available on the market: those that include the push piston along with the paste material and those that only include the paste material. Therefore, according to a preferred first embodiment of the invention, the applicator device will comprise, in addition to the vibratory means, push means formed by a piston. According to a second preferred embodiment of the invention, the applicator device will comprise only the vibratory means.

In a totally equivalent form, the invention may be present in the form of a gun, inside of which are located the vibratory means and the other elements, as well as a cavity for housing a cartridge or even the paste product directly, which is pushed by the action of said vibrator via said membrane*. Sic; the “membrane” is first mentioned below; perhaps the base of the vibratory means is intended here—Translator's note.

As has been mentioned previously, the base of the vibratory means for transmission to the push piston preferably has a small thickness and a large surface, and is joined to the vibrator body by means of its armature, which is a central projection that extends into the front part of said body.

On the other hand, the manner of fastening the applicator device to the inside surface of the container element that contains the cartridge in its front part is the same as described previously, i.e., by means of the applicator device is fastened fastening/unfastening means formed by mobile supports provided with a plurality of elements on their outer surface. In this case, the means for radial outward and inward displacement of these mobile supports are formed by a clamping element, a large button and a spring. The clamping element has an appreciably cylindrical body with a truncated cone front part, like a truncated pyramid, adapted so to remain inserted between the vibrator body and the mobile supports, in order to raise the mobile supports up to their elevated work position. The large button is mounted via the spring in the posterior part of said truncated-cone element, said button being adapted to be activated by the user so that the clamping element is pushed forward and its front part remains inserted between the outer surface of the vibrator body and the inner surface of the mobile supports. In the same way, if the user desires to withdraw the applicator device from inside the container element, he need only pull the button out, whereby the clamping element is removed from its working position and the mobile supports return to their lowered position. The spring has the function of maintaining the position of said button.

The functioning of the applicator device consists of applying alternate current to the vibrator, which generates a forward advance movement of the armature. Whe the AC polarity is reveresed, the armature of the vibrator cannot return to the initial position and is obliged to execute a frontward movement relative to the container element, and when the armature is connected to the mobile supports, then a frontward dragging movement of the entire vibrator body is produced. In this way, the cycle of linear movement frontward is executed, with the subsequent application of pressure of the vibrator base against the push piston.

The vibration produced by the vibratory means can be regulated by several electrical or electronic means that permit adjusting the necessary voltage due to the specific working conditions. Said vibration acts on a base joined in fixed manner to the vibrator armature, which pushes a membrane equipped with elasticity so that it in turn presses the paste material.

On the other hand, operating means for the vibratory means are provided and these are formed by a start switch, or in the case of providing a gun shape, by the trigger thereof. Optionally, a run-end switch will be provided to automatically disconnect the applicator device when the contents of the cartridge have been used up.

Other details and characteristics will become clear in the course of the following description, wherein reference is made to the drawings appended to this specification, in which an illustrative, but non-limiting practical embodiment of the invention is shown.

### DESCRIPTION OF THE FIGURES

FIG. 1 is a lateral sectional view in elevation of propulsion unit (26).

FIG. 2 is a frontal view in elevation of propulsion unit (26), in which the configuration of head (2) is shown.

FIG. 3 is a posterior view in elevation of propulsion unit (26), in which frame (10) is shown, and distributed piercing elements are shown projecting through openings in the frame.

FIG. 4 is a lateral view in elevation of the exterior of case (18) for housing propulsion unit (26).

FIG. 5 is a longitudinal section in elevation of applicator device (1), i.e., the unit formed by propulsion unit (26) mounted inside a case (18).

FIG. 6 is a longitudinal section in elevation of the applicator device in working position, with vibrator element (41) fastened to the inside surface of container element (27).

FIG. 7 is a longitudinal section in elevation of a second embodiment of the applicator device, wherein vibrator (41) is withdrawn, i.e., with vibrator element (41) unfastened from the inside surface of container element (27).

For the purpose of facilitating comprehension, a detailed description of the principal elements of the invention presented in the appended figures is given below: (1) applicator device, (2) head, (3) anterior disk, (4) front [cover] base of the head, (5) mobile supports, (6) inside screw thread of the head, (7) fast[-speed]shaft, (8) slow[-speed] shaft, (9) circular distribution of piercing elements, (10) fastener element, (11) posterior base of the fastener element, (12) openings of the fastener element, (13) conductors, (14) battery holder, (15) gear reducer, (16) poles, (17) electric motor, (18) case, (19) cells or batteries, (20) anterior base of the propulsion element, (21) end-of-course sensors, (22) bolt, (23) sleeve, (24) posterior disk, (25) walls of the electric motor, (26) propulsion unit, (27) inner surface of the case, (28) cartridge of paste material, (29) nozzle opening, (30) outer screw thread of the sleeve, (31) main button, (32) secondary button, (33) connection cable, (34) clutch, (35) central aperture of the front base of the head, (36) perimeter border of the central aperture, (37) front aperture of the case, (38) paste product, (39) piston, (40) piston wing, (41) vibrator body, (42) vibrator armature, (43) support shafts, (44) vibrator base, (45) spring, (46) coupling pin, (47) rod, (48) large button, (49) control button, (50) cables, (51) truncated-cone element, (52) central posterior surface of the piston, and (53) front surface of the piston; the electromagnetic vibrator is not included in the detail of the figures.

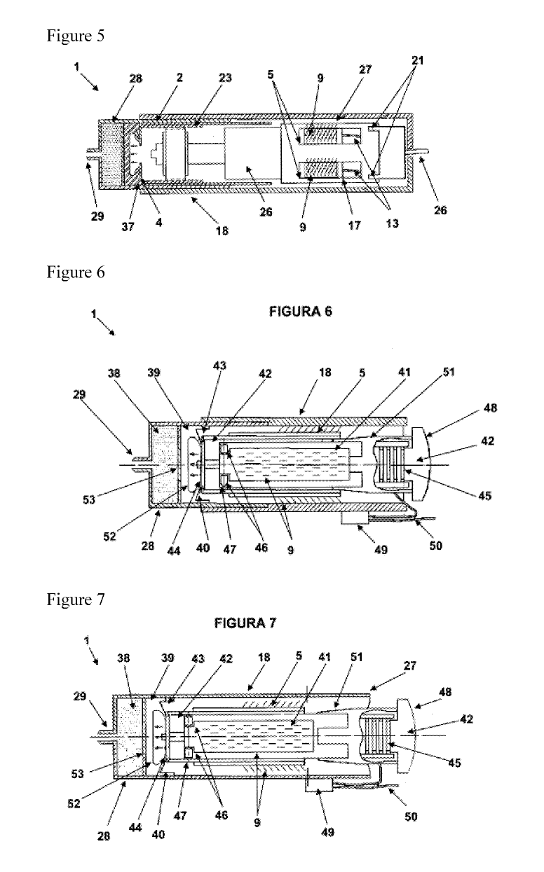

In a preferred embodiment of the subject of the present invention, applicator device (1) is composed of a case (18) that incorporates on its inside a cartridge of paste material (28) in the front part, followed by a propulsion unit (26) and a battery holder (14) in its back part, here the outer case (18) and the battery holder (14) being two independent elements that are mounted in a fixed manner for the functioning of the device; see FIG. 5.

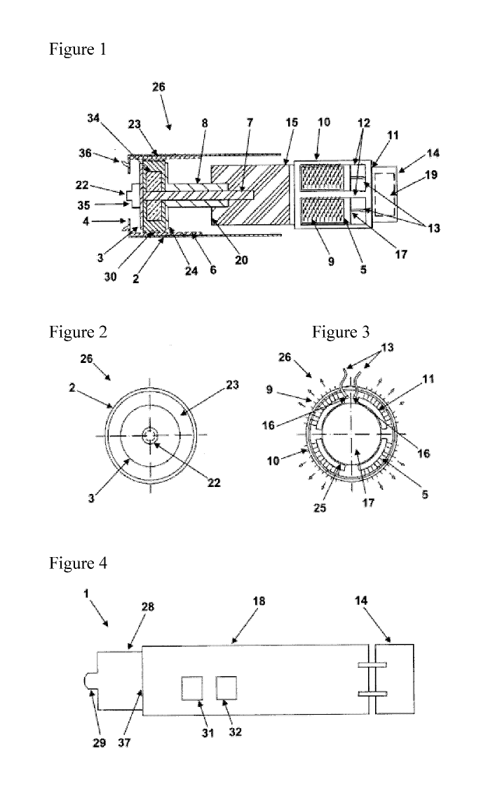

As can be seen in FIG. 1, propulsion unit (26) is formed by a head (2) of cylindrical configuration furnished with a front base (4) which is opened up to form a central orifice (35) and lacking a lower base but having an inner screw thread (6), which provides means for generating longitudinal movement in both directions of said head (2).

Inner perimeter border (36) of central aperture (35) of front base (4) of head (2) has a coupler for fastening to the back part of the cartridge piston.

Said means for generating longitudinal movement is an electric motor (17) of expanded body that is connected via its upper part to a gear reducer (15), from the anterior base (20) of which extend two concentric drive shafts (7-8). Said drive shafts (7-8) which rotate at different speeds transmit the translation movement to head (2) via a cylindrical sleeve (23) externally threaded with a screw thread (30), which transmits the rotational movement from one shaft (7-8) or the other as translation movement to head (2). The conversion of rotational movement to longitudinal translation movement is achieved due to the connection between the two elements (head (2) and sleeve (23)) via a threaded-screw connection.

The selection of the speed of rotation of sleeve (23) is made by means of a clutch (34), which is solidly connected to one shaft (7) or the other (8), depending on the functioning mode of applicator device (1). Clutch (34) incorporates two disks: an anterior disk (3) and a posterior disk (24), each of which is joined to one rotating shaft (7-8). In concrete terms, fast[-speed] shaft (7) is joined immobilized to anterior disk (3) by means of a bolt (22).

The functioning of propulsion unit (26) is based on the advance and return of head (2) via the outside of the outer cylindrical surface of sleeve (23), thanks to the rotation of said sleeve (23) induced by fast[-speed] shaft (7) or slow[-speed] shaft (8) associated with the electric motor assembly (17) and gear reducer (15) and thanks to the provision of coincident screw threads (11* and 30) in head (2) and sleeve (23), respectively. sic; 6?—Trans. Note.

The electric motor (17) has in its back part a fastener element (10) mounted around it and above mobile supports (5). Said fastener element (10) of cylindrical configuration is furnished with a plurality of rectangular openings (12), through which projects the circular distribution of piercing elements (9) that project from the outer surface of mobile supports (5).

When electric motor (17), is switched [reversed] of the rotational direction of shaft (7 or 8) is reversed, and subsequently an advance/return of head (2) via the outside of sleeve (23) is achieved, and this cycle can be repeated as many times as desired.

Mobile supports (5) with piercing elements (9) operate in a way that when electric motor (17) is operated, said mobile supports (5) are displaced outward in the direction of the arrows according to FIG. 3, tightening the free ends of piercing elements (9) against the back inside surface of case (18). In the same way, when the rotation of electric motor (17) is changed, said mobile supports (5) are moved inward and are no longer held at the inside surface of case (18), whereby the fixed part of propulsion unit (26) is moved back the [same] distance that head (2) has advanced in the advance phase.

As can be seen in FIG. 1, the ends of piercing elements (9) are slightly inclined relative to the longitudinal direction of case (18).

Batteries or cells (19) that supply electric motor (17) and gear reducer (15) can be mounted in their holder (14) that is coupled behind electric motor (17) as a continuation of propulsion unit (26), as can be seen in FIG. 1, or separate from this, as is shown in FIG. 4, without modifying the essence of the invention. Another possible configuration is to connect propulsion unit (26) to the electrical grid by means of a connection cable (33)*. This cable may be indicated on the right of FIG. 5 with he (incorrect) number (26)—Trans. Note.

Described propulsion unit (26) is mounted inside a case (18) of expanded configuration, so that the cartridge of paste material (28) is disposed in the front part of propulsion unit (26) projecting through front aperture (37) and with part of the piston of cartridge (28) on the side of head (2), whereas propulsion unit (26) remains mounted behind the piston of cartridge (28).

Propulsion unit (26) is immobilized at the inside surface of case (18) by the retaining action of piercing elements (9) of mobile supports (5) against the inside surface of case (18) so that when poles (16) of electric motor (17) receive voltage thanks to cells/batteries (19) by means of electrical conductors (13) or instead by means of the electrical grid, a mechanism of raising/lowering supports exists that transmits the outward/inward radial displacement of mobile supports (5).

Case (18) incorporates on its outer side several buttons (main button (31) and secondary button (32) respectively, for starting up propulsion unit (26) and for releasing propulsion unit (26) from case (18) and, in this way, for example, being able to remove empty cartridge (28) from case (19). On the other hand, several end-of-course sensors (21) for controlling the advance/return of head (2) through the inside of sleeve (23) are provided on the posterior end of the fixed part of propulsion unit (26), said sensors (30)* being activated by contact of the lower part of head (2) when it reaches a specific position relative to the fixed part of propulsion unit (26). sic; (21)—Trans. Note.

The cylindrical configuration has been selected for both case (18) as well as head (2) and for other elements as an ergonomic configuration that is inexpensive to manufacture.

However, it is easy to comprehend that the selection of other configurations for these parts of applicator device (1) will not alter the essence of the invention.

The vibratory system is shown in FIGS. 5 and 6, it being evident that the same configuration of applicator device (1) is maintained, composed of a case or container element (18) of preferably cylindrical configuration, in the interior of which is positioned a paste product (38) contained inside a cylindrical cartridge (28) that integrates the discharge nozzle opening (29), said cartridge (28) being inserted in the front part inside container element (18).

In this particular case, a push piston (39) for paste material (38) is integrated in cartridge (28) itself However, the device may also have a a push piston (39) that is mounted in a fixed manner in the front part of base (44) of vibrator (41). In both cases, push piston (39) has a planar front surface (53) adapted so as to exercise pressure against the mass of paste material (38) and a back surface furnished with a lateral wing (40) that is extended inside, forming a depressed central surface (52).

Also inside container element (18) and adjacent to cartridge (28) is situated the vibratory means formed by a body (41) of generally expanded configuration that contains on its inside the electromagnetic vibrator, which is not shown in the appended figures, and several mobile supports (5) are provided around said body (41). The vibrator armature (42), which is responsible for transmitting the vibratory movement, is disposed in the front part of said vibrator body (41).

A base (44), whose task is to exercise pressure on said wing (40) of piston (39) is provided in the front part of said vibrator body (41), mounted jointly at said armature (42). On the other hand, said base (44) remains joined in fixed manner with mobile supports (5) by means of several [support] shafts (43). In this way, base (44) receives the vibratory movement of armature (42), which transmits it to push piston (39), while it is simultaneously connected to the container element by means of piercing elements (9) of the already described mobile supports (5).

Said vibrator [body] (41) remains joined to inner surface (27) of container element (18) with the help of mobile supports (5), joined to vibrator [body] (41) via its base (44) with several [support] shafts (43), the ends of which are connected thanks to several coupling pins (46) joined with a rod (47).

Said connection of mobile supports (5) with the inside surface of container element (18) via piercing elements (9) makes it possible for the entire vibrator body (41) to be displaced only in the frontward direction with respect to container element (18).

Said piercing elements (9) which are disposed over the entire outer surface of mobile supports (5) project radially outward with an inclination of 45° approximately with respect to the longitudinal direction of container element (18), this angle being necessary, as was referenced above, and preferably between 45° and 80°.

On the other hand, mobile supports (5) have several means for raising/lowering in the radial direction, essentially formed by a clamping element (51), a large button (48) and a spring (45). Clamping element (51), in the form of a truncated cone, has an appreciably cylindrical body, it being adapted so as to be mounted in the back part of vibrator body (41) and with dimensions such that it can be inserted between vibrator body (41) and mobile supports (5). In the posterior part of said clamping element (51) is mounted a large button (48) via a spring (45), said button (48) being adapted so that it can be activated by the user in order to push the clamping element (51) frontward in such a way that its front part remains inserted between the outer surface of vibrator body (41) and the interior surface of mobile supports (5); see FIG. 6. In the same manner, if the user desires to withdraw applicator device (1) from inside container element (18), button (48) need only be pulled out, whereby clamping element (51) is taken out of its work position and mobile supports (5) return to their lowered position; see FIG. 7.

The vibrator can be furnished with an electrical or electronic voltage regulator, which is not shown in the figures, which permits adjusting the necessary voltage due to the specific work conditions at each moment and regulating the frequency of vibration over base (44) that acts on piston (39).

The electromagnetic vibrator is activated by means of a start switch (49) disposed in the outer part of container element (18), adapted to be operated by the user in order to turn on said electromagnetic vibrator.

Optionally, a run-end switch will be provided, which is not shown in the figures which is adapted so as to automatically disconnect the electromagnetic vibrator when the content of cartridge (28) has been completely used up.

With particular reference to FIG. 7, a second embodiment of applicator device (1) is shown, in which said applicator device (1) has a push piston (39) integrated in the front part. This second embodiment will be used in those cases in which push piston (39) is not incorporated in the cartridge of paste material. Push piston (39) has a planar front surface (53) joined in fixed manner to base (44) of applicator device (1) and is adapted to exercise pressure against the paste material (38).

Now that the present invention has been described in accord with and corresponding to the appended figures, it is not considered necessary to further expand this description, since a person skilled in the art will comprehend the scope of the invention and the advantages that can be derived therefrom. The materials, shape, size and disposition of the elements may be varied by introducing any modifications that are considered suitable, always without altering the essence of the invention that is summarized in the claims that are presented in detail below. In any case, the terms in which this specification has been drafted must always be taken in full, non-restrictive sense.

1. A device for applying paste products of the type that is adapted to be mounted coupled behind a conventional cartridge that is provided with a piston, a container of paste material, such as silicone materials, sealing materials, adhesives, anti-oxidants, greases, and similar materials, and a discharge nozzle opening, characterized in that it comprises a propulsion unit formed by a head of cylindrical configuration, furnished with a cover in its front part and contacting the lateral front section of the internally screw-threaded head that remains joined by its inside screw-threaded surface via a screwed connection to the outer screw-threaded surface of a sleeve of cylindrical configuration, the respective screw threads of head and sleeve being of suitable conformation, said sleeve being joined to a disk that rotates jointly with a shaft of an electric motor, said electric motor being connected to several operating means and to an epicycloidal gear reducer that adapts the speed of its output shaft, the functioning of propulsion unit consisting of the advance and return of head always the outside of the outer cylindrical surface of sleeve thanks to the rotation of said sleeve in the two directions transmitted by shaft of gear reducer, said gear reducer being able to have a single output shaft and the assembly being able to incorporate vibratory means adapted so as to generate a forward advance movement of applicator device.

2. The device for applying paste products according to the first claim, further characterized in that front cover of head is provided with a central aperture of smaller diameter than the overall diameter, and whose perimeter border will form a coupling with the piston of paste material cartridge so as to keep head completely fastened to cartridge.

3. The device for applying paste products according to the first claim, further characterized in that gear reducer has two output shafts, each of which is connected to a different stage of gear reducer in such a way that the two shafts rotate at different speeds, said output shafts being joined to two disks and one or the other of disks being connected to sleeve by means of a clutch, and one output shaft being able to be mounted coaxially to the other output shaft.

4. The device for applying paste products according to the first claim, further characterized in that means for operating the electric motor can be formed by a battery or cells connected to said electric motor or by a connection cable that is connected to the electrical grid.

5. The device for applying paste products according to the first claim, further characterized in that propulsion unit is housed inside a case provided with a space in the front part for accommodating cartridge and with a space in the back part for accommodating propulsion unit and furnished with an aperture in its front part to permit the removal of cartridge, propulsion unit being fastened to back inner surface of case by means of several fastening means, and front inner surface of case being fastened to inner surface of cartridge by means of several fastening means.

6. The device for applying paste products according to the fifth claim, further characterized in that means for fastening the fixed part of propulsion unit to case are formed by several mobile supports that are mounted around the frame of electric motor and that have on their surface several piercing elements projecting out, these piercing barb elements being in the form of metal filaments and having a certain necessary angle with respect to the longitudinal direction of case, said angle being understood to be preferably between 45° and 80°, said mobile supports being adapted to be displaced radially outward in order to start up electric motor, allowing the ends of piercing elements to press against the inner surface of case, and again to be displaced downward to the initial position in order to turn off electric motor, by being released from the inside surface of case.

7. The device for applying paste products according to the fifth claim, further characterized in that means for fastening case to cartridge are formed by several elements projecting from the case and directed toward the cartridge, adapted for coupling to the outer surface of the cartridge and thus immobilizing both elements providing said case with several means for operating propulsion unit by the user, these means made up of a start/stop button.

8. The device for applying paste products according to the first claim, further characterized in that propulsion unit provides several end-of-course sensors to control the advance/return of head relative to the fixed part of propulsion unit said sensors being activated by contact with head when a specific position is reached relative to the fixed part of propulsion unit.

9. The device for applying paste products according to the first claim, further characterized in that a control system is provided, which is designed to activate the rotation of electric motor as soon as start button is activated, and when this is released the rotation of electric motor is switched [reversed], or a second control system designed so that once electric motor is activated, disk joined to slow-speed shaft is automatically connected to sleeve, and once the direction of rotation of electric motor is changed, disk joined to fast-speed shaft is automatically connected to sleeve.

10. The device for applying paste products according to the first claim, further characterized in that it comprises several vibratory means adapted so as to generate a forward advance movement of applicator device relative to the container element or case, said vibratory means being combined with corresponding transmission means, formed by a base adapted to form a cover and to press against the posterior face of a push piston of a paste material, with several fastening/releasing means for applicator device on the inside surface of container element, and with means for operating said vibratory means.

11. The device for applying paste products according to the tenth claim, further characterized in that the vibratory means are formed by an electromagnetic vibrator contained inside a body, of expanded configuration, and furnished with an armature that extends through the front part of vibrator body.

12. The device for applying paste products according to the tenth claim, further characterized in that mobile supports are joined to vibrator body via its base having several [support] shafts and that they are connected by their ends thanks to several coupling pins joined with a rod.

13. The device for applying paste products according to the tenth claim, further characterized in that the means for radial displacement outward and inward of said mobile supports are formed by a clamping element, which has an expanded cylindrical body with a truncated-cone front part, adapted to be inserted between the vibrator body and mobile supports, a large button mounted in the back part of clamping element and designed to be activated by the user and to push said clamping element forward or backward, and a spring designed to maintain the position of said button.

14. The device for applying paste products according to the tenth claim, further characterized in that base for transmission of vibratory means to push piston is mounted by joining to armature of the vibrator provided in the front part of vibrator body.

15. The device for applying paste products according to the tenth claim, further characterized in that the means for operating the vibratory means are formed by a start button adapted for connecting the vibrator by means of operating said button.

16. The device for applying paste products according to the tenth claim, further characterized in that the electrical supply means of the vibrator can be formed by several batteries in combination with a current inverter, or by a cable designed to be connected directly to the electrical grid, providing an electrical or electronic voltage regulator connected to the electromagnetic vibrator and a run-end switch, designed for automatically disconnecting the electromagnetic vibrator when the entire content of cartridge is used up.

17. The device for applying paste products according to the tenth claim, further characterized in that a push piston of planar front surface is provided, which is joined in a fixed manner to base of applicator device, desigend to exercise pressure against the paste material.
